(19) United States
(12) Patent Application Publication
(10) Pub. No.: US 2026/0066389 A1
(43) Pub. Date: Mar. 5, 2026

(54) COOLING SYSTEM FOR BATTERY MODULE

(71) Applicants: SK INNOVATION CO., LTD., Seoul (KR); SK ENMOVE CO., LTD., Seoul (KR)

(72) Inventor: Min Je PARK, Daejeon (KR)

(21) Appl. No.: 19/296,946

(22) Filed: Aug. 12, 2025

(30) Foreign Application Priority Data
Sep. 2, 2024 (KR) 10-2024-0118781

(51) Int. Cl. H01M 10/656; H01M 10/613; H01M 50/258

(52) U.S. Cl. CPC H01M 10/656; H01M 10/613; H01M 50/258

(57) ABSTRACT

A battery module cooling system including an inlet into which cooling fluid is introduced, a first parallel system configured by connecting n battery modules in parallel to which the cooling fluid introduced from the inlet is supplied, a second parallel system configured by connecting m battery modules in parallel, with m being a number less than n, to which the cooling fluid flowing out from the first parallel system is supplied, a third parallel system configured by connecting s battery modules in parallel, with s being a number less than m, to which the cooling fluid flowing out from the second parallel system is supplied, and an outlet through which the cooling fluid that has passed through the third parallel system flows out.

### CROSS REFERENCE TO RELATED APPLICATION

The present application claims priority to Korean Patent Application No. 10-2024-0118781, filed September 02, 2024, the entire contents of which is incorporated herein for all purposes by this reference.

### BACKGROUND

### Field of the Invention

The embodiments of the present disclosure relate generally to battery technology and, more particularly, to a battery module cooling system.

### Description of the Related Art

In recent years, as mobile devices such as mobile phones and laptops have become smaller and lighter, and electric vehicles and hybrid vehicles demand high-capacity power sources, a variety of batteries are being developed and used.

In the case of secondary batteries, efficiency is becoming increasingly important depending on the application field, but problems, such as heat generation and fires during charging or operation, occur primarily due to external factors.

Accordingly, technologies are being developed to increase the operating efficiency of secondary batteries and also to ensure safety.

Moreover, a recent surge in the overall usage of electricity has led to increased carbon emissions and exacerbated global warming concerns, which has led to demand for more efficient device operation mechanisms and maximizing cooling efficiency therefor.

### SUMMARY

According to an embodiment of the present disclosure, there is provided a battery module cooling system that increases the cooling efficiency of battery modules. The battery module cooling system also improves the efficiency of cooling fluid usage by controlling the flow rate and speed (velocity) of the cooling fluid that is circulated in the cooling system for cooling the battery modules.

A battery module cooling system according to an embodiment of the present disclosure may include an inlet into which cooling fluid is introduced; a first parallel system configured by connecting n battery modules in parallel to which the cooling fluid introduced from the inlet is supplied; a second parallel system configured by connecting m battery modules in parallel, with m being a number less than n, to which the cooling fluid flowing out from the first parallel system is supplied; a third parallel system configured by connecting s battery modules in parallel, with s being a number less than m, to which the cooling fluid flowing out from the second parallel system is supplied; and an outlet through which the cooling fluid that has passed through the third parallel system flows out.

In this case, the cooling fluid may be supplied evenly to each of n battery modules of the first parallel system, and the cooling fluid that has passed the first parallel system may be supplied evenly to each of m battery modules of the second parallel system, and then the cooling fluid that has passed the second parallel system may be supplied evenly to each of s battery modules of the third parallel system.

In addition, a total flow rate of cooling fluid passing through n battery modules of the first parallel system, a total flow rate of cooling fluid passing through m battery modules of the second parallel system, and a total flow rate of cooling fluid passing through s battery modules of the third parallel system may be all the same.

In addition, a flow rate of a cooling fluid passing through one of m battery modules of the second parallel system may be 2 to 3 times greater than a flow rate of a cooling fluid passing through one of n battery modules of the first parallel system.

In addition, a flow rate of a cooling fluid passing through one of s battery modules of the third parallel system may be 2 to 3 times greater than a flow rate of a cooling fluid passing through one of m battery modules of the second parallel system.

In addition, a velocity of a cooling fluid passing through one of m battery modules of the second parallel system may be 2 to 3 times greater than a velocity of a cooling fluid passing through one of n battery modules of the first parallel system.

In addition, a velocity of a cooling fluid passing through one of s battery modules of the third parallel system may be 2 to 3 times greater than a velocity of a cooling fluid passing through one of m battery modules of the second parallel system.

In addition, in the case that a temperature of the cooling fluid flowing into the first parallel system from the inlet is referred to as a first temperature, a temperature of the cooling fluid flowing out of the first parallel system and flowing into the second parallel system is referred to as a second temperature, and a temperature of the cooling fluid flowing out of the second parallel system and flowing into the third parallel system is referred to as a third temperature, the second temperature may be higher than the first temperature, and the third temperature may be higher than the second temperature, wherein a difference in a flow rate of cooling fluid flowing into each of the battery modules of the first parallel system and a flow rate of cooling fluid flowing into each of the battery modules of the second parallel system may be adjusted in proportion to a difference between the first temperature and the second temperature, and a difference between a flow rate of cooling fluid flowing into each of the battery modules of the second parallel system and a flow rate of cooling fluid flowing into each of the battery modules of the third parallel system may be adjusted in proportion to a difference between the second temperature and the third temperature.

In addition, n, the number of battery modules of the first parallel system, may be at least twice m, the number of battery modules of the second parallel system, and m, the number of battery modules of the second parallel system, may be at least twice s, the number of battery modules of the third parallel system.

A battery module cooling system according to another embodiment of the present disclosure may include at least first to third parallel systems operatively coupled in series, wherein the cooling fluid is introduced into the first parallel system for cooling a first plurality of battery modules, the cooling fluid exiting from the first parallel system is fed to the second parallel system for cooling a second plurality of battery modules, the cooling fluid exiting from the second parallel system is fed into the third parallel system for cooling one or more battery modules, the second plurality of battery modules is less than the first plurality of battery modules, the one or more battery modules of the third battery system is less than the second plurality of battery modules, the cooling fluid volumetric flow rate through the second parallel system is greater than the volumetric flow rate of the cooling fluid through the first parallel system, and the cooling fluid volumetric flow rate through the third parallel system is greater than the cooling fluid volumetric flow rate through the second parallel system.

In this case, the cooling fluid may be supplied evenly to each of the first plurality of battery modules of the first parallel system, the cooling fluid that has passed through the first parallel system may be supplied evenly to each of the second plurality of battery modules of the second parallel system, and the cooling fluid that has passed through the second parallel system may be supplied evenly to each of the one or more battery modules of the third parallel system.

The features and advantages of the embodiment of the present disclosure will become more apparent from the following detailed description based on the accompanying drawings.

According to an embodiment of the present disclosure, by appropriately controlling the circulation path and circulation flow rate of a cooling fluid flowing between battery modules, cooling efficiency with the cooling fluid can be maximized.

Furthermore, by maximizing the cooling efficiency for battery modules, energy efficiency can be increased and power usage can be reduced when cooling battery modules, thereby reducing carbon emissions that come from the operation of related devices.

Furthermore, as a cooling system that can be applied to various structures in which a plurality of battery modules are combined, it is possible to increase the freedom in designing the combined structure of battery modules and the cooling system.

### BRIEF DESCRIPTION OF THE DRAWINGS

FIG. 1 is a simplified schematic illustrating the circulation structure of a battery module cooling system according to an embodiment of the present disclosure.

FIG. 2 is a simplified schematic illustrating a plurality of battery modules combined with the cooling system of FIG. 1.

### DETAILED DESCRIPTION

Embodiments of the present disclosure will now be described in reference to the drawings.

It should be noted that terms or words used in this specification and claims should not be construed in their usual, dictionary meaning, but should be interpreted with meanings and concepts consistent with the technical ideas of the present disclosure.

Moreover, it is also noted that terms used to describe the embodiment(s) of the present disclosure are not intended to limit the scope of the present disclosure. It should also be noted that a singular expression as used herein may include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated in certain respects for the purpose of illustrating the features of the embodiments while commonly known features may be omitted. In this specification, expressions such as “have”, “may have”, “include”, or “may include” may refer to the presence of a corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

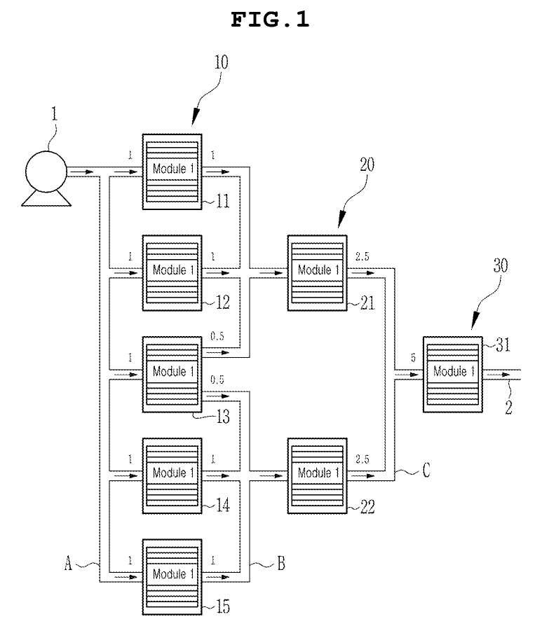

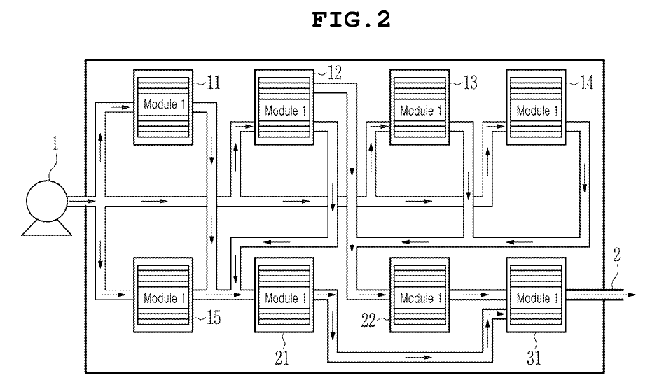

FIG. 1 is a view showing a circulation structure of a battery module cooling system according to an embodiment of the present disclosure, and FIG. 2 is a schematic view of a plurality of battery modules combined with the cooling system of FIG. 1.

A battery module cooling system according to an embodiment of the present disclosure may include an inlet 1 into which cooling fluid is introduced; a first parallel system 10 configured by connecting n battery modules in parallel to which the cooling fluid introduced from the inlet 1 is supplied; a second parallel system 20 configured by connecting m battery modules in parallel, with m being a number less than n, to which the cooling fluid flowing out from the first parallel system 10 is supplied; a third parallel system 30 configured by connecting s battery modules in parallel, with s being a number less than m, to which the cooling fluid flowing out from the second parallel system 20 is supplied; and an outlet 2 through which the cooling fluid that has passed through the third parallel system 30 flows out.

The inlet 1 serves to supply the cooling fluid that circulates inside the cooling system to cool the battery modules. Although a single inlet 1 is shown in the drawing, the number or arrangement of the inlets 1 is not limited thereto.

As shown in FIG. 1, the first parallel system 10 may comprise, for example, first to fifth battery modules 11 to 15, the second parallel system 20 may comprise a sixth battery module 21 and a seventh battery module 22, and the third parallel system 30 may comprise one single eighth battery module 31.

The configuration in FIG. 1 is only an embodiment, and the number and arrangement of battery modules included in each one of the parallel systems may be freely designed and changed within the scope of the technical idea according to various embodiments of the present disclosure.

The first parallel system 10 may have a form in which a plurality of battery modules are connected in parallel.

The cooling system may be initially supplied with cooling fluid flowing in from the inlet 1 to cool the battery modules.

As shown in FIG. 1, the first parallel system 10 represents an embodiment in which two or more battery modules, that is, n battery modules, are connected in parallel, however other numbers of battery modules may be used.

To be specific, the first battery module 11, a second battery module 12, a third battery module 13, a fourth battery module 14, and the fifth battery module 15 are connected in parallel, and the cooling fluid flowing in from the inlet 1 may be supplied to each battery module through a first supply pipe A.

After the cooling of the first parallel system 10 is completed, the discharged cooling fluid may be supplied to the second parallel system 20 through a second supply pipe B. The second parallel system 20 may be configured by connecting m battery modules in parallel, with m being less than n battery modules of the first parallel system 10.

The cooling fluid that has passed through the second parallel system 20 is supplied to the third parallel system 30 through a third supply pipe C. At this time, the third parallel system 30 may be configured by connecting s battery modules in parallel, with s being less than m battery modules of the second parallel system 20.

The cooling fluid that has passed through the third parallel system 30 flows out to the outside through the outlet 2.

Although in an embodiment of the present disclosure, the battery module cooling system is shown as consisting of a three-stage parallel system of the first parallel system 10, the second parallel system 20, and the third parallel system 30, the number or arrangement of these stages may be appropriately changed or adjusted in consideration of the number of battery modules, cooling efficiency, etc.

In addition, the battery modules included in the first parallel system 10, the second parallel system 20, and the third parallel system 30 are all battery modules with the same specifications, and the size and length of a flow path of the cooling fluid passing through the interior of each battery module are also the same. However, within the scope reflecting the technical idea of the present disclosure, the size, number, etc., of the flow path of the cooling fluid formed inside the battery module may be appropriately changed.

The cooling fluid is supplied evenly to each of n battery modules of the first parallel system 10, and the cooling fluid that has passed the first parallel system 10 may be supplied evenly to each of m battery modules of the second parallel system 20, and then the cooling fluid that has passed the second parallel system 20 may be supplied evenly to each of s battery modules of the third parallel system 30.

In addition, in this case, the total flow rate of the cooling fluid passing through n battery modules of the first parallel system 10, the total flow rate of cooling fluid passing through m battery modules of the second parallel system 20, and the total flow rate of cooling fluid passing through s battery modules of the third parallel system 30 are all the same.

That is, the total flow rate of the cooling fluid flowing in from the inlet 1 is sequentially supplied to the first parallel system 10, the second parallel system 20, and the third parallel system 30, and the flow rate and velocity of the cooling fluid passing through each battery module may be controlled depending on the number of battery modules in each parallel system.

As shown in FIG. 1, the inlet 1 may supply an equal amount of cooling fluid to each of n battery modules of the first parallel system 10 through the first supply pipe A.

At this time, when the same flow rate is supplied to each battery module, an internal cooling channel may be formed so that the velocity of the cooling fluid is also maintained the same.

The cooling fluid that has passed the first parallel system 10 is supplied to the second parallel system 20, which is the next stage. Since the second parallel system 20 is composed of m battery modules, which are fewer than n battery modules of the first parallel system 10, the flow rate of the cooling fluid flowing into each battery module of the second parallel system 20 may be greater than the flow rate of the cooling fluid flowing into each battery module of the first parallel system 10.

In particular, cooling efficiency may be improved by supplying the cooling fluid, whose temperature has increased while passing through the first parallel system 10, to each battery module of the second parallel system 20 at a larger flow rate.

In a similar manner, the cooling fluid flowing through the second parallel system 20 may be supplied to the third parallel system 30. Since the third parallel system 30 is composed of s battery modules, which are fewer than m battery modules of the second parallel system 20, the flow rate of the cooling fluid flowing into the individual battery modules of the third parallel system 30 may be greater than the flow rate of the cooling fluid flowing into the individual battery modules of the second parallel system 20.

As the cooling fluid, whose temperature has increased by passing through the second parallel system 20, is supplied to the individual battery modules of the third parallel system 30 at a flow rate greater than the flow rate of the cooling fluid supplied to the individual battery modules of the second parallel system 20, the cooling efficiency of the cooling fluid may be further maximized.

To be specific, the flow rate of the cooling fluid passing through one of m battery modules of the second parallel system 20 may be 2 to 3 times greater than the flow rate of the cooling fluid passing through one of n battery modules of the first parallel system 10.

In addition, the flow rate of the cooling fluid passing through one of s battery modules of the third parallel system 30 may be 2 to 3 times greater than the flow rate of the cooling fluid passing through one of m battery modules of the second parallel system 20.

By controlling the flow rate of the cooling fluid passing through each of the battery modules, the battery modules may be cooled to maintain the appropriate temperature that should be maintained, and the cooling fluid, whose temperature has increased by passing through the first parallel system 10, may also efficiently cool each battery module of the second parallel system 20. In addition, the cooling fluid, whose temperature has increased by passing through the second parallel system 20 may effectively maintain the cooling of each battery module when passing through the third parallel system 30. However, the difference in the flow rate of the cooling fluid may be appropriately changed and adjusted depending on the number of battery modules or the number of parallel system stages.

In conclusion, by ensuring that the cooling fluid passing through the first parallel system 10, the second parallel system 20, and the third parallel system 30 maintains the cooling efficiency thereof for the battery modules until the cooling fluid passes through the last third parallel system 30, the entire battery module cooling system may be operated stably.

In addition, the specifications, such as the size and length of the cooling channel formed inside each of the battery modules and through which the cooling fluid passes, are applied equally to all battery modules in the cooling system, so that by controlling the flow rate of the cooling fluid passing through the cooling channel, the velocity of the cooling fluid passing through the cooling channel may also be controlled.

To be specific, the diameters of the cooling channels installed inside all respective battery modules within the battery module cooling system are designed to be the same, the velocity of the cooling fluid passing through one of m battery modules of the second parallel system 20 may be designed to flow 2 to 3 times greater than the velocity of the cooling fluid passing through one of n battery modules of the first parallel system 10.

Similarly, the cooling fluid passing through one of s battery modules of the third parallel system 30 may be set to flow at a velocity that is 2 to 3 times greater than the velocity of the cooling fluid passing through one of m battery modules of the second parallel system 20, so that the cooling fluid, whose temperature has increased by passing through each parallel system, may maintain and maximize cooling efficiency when cooling the battery modules in the subsequent stages.

A feature of the embodiment of the present disclosure is that the number of battery modules included in the first parallel system 10, the second parallel system 20, and the third parallel system 30 gradually decreases as the cooling fluid passes from one stage to the next stage, i.e., as the cooling fluid passes from the first stage, to the second stage and then from the second stage to the third stage. By first, second, and third stages we refer to the first, second, and third parallel systems 10, 20 and 30.

As an example, in a specific embodiment, n may be the number of battery modules of the first parallel system 10 and may be at least twice the number m, which is the number of battery modules of the second parallel system 20, and m, i.e., the number of the battery modules of the second parallel system 20, may be at least twice the number s which is the number ofthebattery modules of the third parallel system 30. By doing so, the cooling efficiency of the cooling fluid for the battery modules may be further enhanced by making the flow rate or velocity of the cooling fluid flowing in each parallel system different.

The relative difference in the number of battery modules between parallel systems and the flow rate of the cooling fluid may be controlled depending on the degree of temperature increase after the cooling fluid performs cooling of one system, the number of parallel systems through which the cooling fluid circulates and cools, etc.

For example, the temperature of the cooling fluid flowing into the first parallel system 10from the inlet 1 is referred to as a first temperature, the temperature of the cooling fluid flowing out of the first parallel system 10 and flowing into the second parallel system 20 is referred to as a second temperature, and the temperature of the cooling fluid flowing out of the second parallel system 20 and flowing into the third parallel system 30 is referred to as a third temperature. According to this example, the second temperature may be higher than the first temperature, and the third temperature may be higher than the second temperature.

Also, in this case, the difference in the flow rate of the cooling fluid flowing into each battery module of the first parallel system 10 and the flow rate of the cooling fluid flowing into each battery module of the second parallel system 20 may be adjusted in proportion to the difference between the first temperature and the second temperature, and the difference between the flow rate of the cooling fluid flowing into each battery module of the second parallel system 20 and the flow rate of the cooling fluid flowing into each battery module of the third parallel system 30 may be adjusted in proportion to the difference between the second temperature and the third temperature. At this time, proportional to the temperature difference does not simply mean proportionality of integer multiples, but includes both linear and nonlinear relationships, and can be interpreted to mean that the flow rate of the cooling fluid may be adjusted correspondingly according to the temperature difference.

In FIG. 1, cooling fluid is divided equally between the 5 battery modules 11 to 15 of the first parallel system 10. The same fluid entering battery modules 11, 12, 14, and 15 also exits these battery modules. But for the battery module 13 which is positioned in the middle of the first parallel system 10, the flow of the cooling fluid entering is divided into two equal exit streams. One of the exit streams of the battery module 13 is combined with the exit streams of the battery modules and 12 and the combined stream is fed into the battery module 21 of the second parallel system 20. The other of the exit streams of the battery module 13 is combined with the exit stream of the battery modules 14 and 15 and the combined stream is fed into the battery module 22 of the second parallel system 20. In the next stage the exit streams from each of the battery modules 21 and 22 are combined to a larger stream and fed to the battery module 31 of the third parallel system 30. Hence, provided the size (i.e., the cross-sectional area) of the cooling fluid channels in the first, second, and third systems is the same, it follows that the volumetric flow rate increases from stage 1 to stage 2, and from stage 2 to stage 3.

Here, the numerical values indicated on each of the supply pipes (A, B, C) for each battery module in FIG. 1—namely 0.5, 1.0, 2.5, and 5.0—are provided by way of example to represent relative values or ratios of the flow rate of the cooling fluid flowing through the respective pipes, and are not intended to limit the present disclosure to any specific numerical values.

As shown in FIG. 2, in order to appropriately control the flow rate or velocity of the cooling fluid flowing between the first parallel system 10, the second parallel system 20, and the third parallel system 30 of the cooling system as shown in FIG. 1, the arrangement structure of the battery modules may be appropriately changed to suit the applied device.

That is, even if the battery modules are arranged in two rows as shown in FIG. 2, by determining individual battery modules corresponding to the first parallel system 10, the second parallel system 20, and the third parallel system 30, and connecting the supply pipes through which the cooling fluid flows into the corresponding battery modules in parallel with the individual battery modules, the cooling system according to an embodiment of the present disclosure may be implemented even in various combination structures of battery modules. For example, in the configuration of FIG. 2, the battery modules 11, 12, 13, 14 and 15 form a first parallel system with a first cooling fluid flow rate through each one of these, battery modules 21 and 22 form the second parallel system with an increased cooling fluid flow rate, and module 31 is the third parallel system with an even greater cooling fluid flow rate. The embodiments of the present disclosure have been described above in detail through specific embodiments. The embodiments are for specifically describing the concepts of the present disclosure, and are only illustrative and are not intended to limit the scope of the embodiments as defined in the appended claims. It should be rather apparent to those skilled in the art that various changes and modifications to the described embodiments are possible within the scope and technical concepts of the present disclosure, and it is natural that such changes and modifications fall within the scope of the appended claims. Furthermore, the embodiments may be combined to form additional embodiments.

What is claimed is:

1. A battery module cooling system comprising:
an inlet into which cooling fluid is introduced;
a first parallel system configured by connecting n battery modules in parallel to which the cooling fluid introduced from the inlet is supplied;
a second parallel system configured by connecting m battery modules in parallel, with m being a number less than n, to which the cooling fluid flowing out from the first parallel system is supplied;
a third parallel system configured by connecting s battery modules in parallel, with s being a number less than m, to which the cooling fluid flowing out from the second parallel system is supplied; and
an outlet through which the cooling fluid that has passed through the third parallel system flows out.

2. The system of claim 1, wherein:
the cooling fluid is supplied evenly to each of the n battery modules of the first parallel system, the cooling fluid that has passed through the first parallel system is supplied evenly to each of the m battery modules of the second parallel system, and
the cooling fluid that has passed through the second parallel system is supplied evenly to each of the s battery modules of the third parallel system.

3. The system of claim 2, wherein a total flow rate of cooling fluid passing through the n battery modules of the first parallel system, a total flow rate of cooling fluid passing through the m battery modules of the second parallel system, and a total flow rate of cooling fluid passing through the s battery modules of the third parallel system are all the same.

4. The system of claim 3, wherein a flow rate of a cooling fluid passing through one of the m battery modules of the second parallel system is 2 to 3 times greater than a flow rate of the cooling fluid passing through one of the n battery modules of the first parallel system.

5. The system of claim 3, wherein a flow rate of a cooling fluid passing through one of the s battery modules of the third parallel system is 2 to 3 times greater than a flow rate of the cooling fluid passing through one of the m battery modules of the second parallel system.

6. The system of claim 3, wherein a velocity of a cooling fluid passing through one of the m battery modules of the second parallel system is 2 to 3 times greater than a velocity of the cooling fluid passing through one of the n battery modules of the first parallel system.

7. The system of claim 3, wherein a velocity of a cooling fluid passing through one of the s battery modules of the third parallel system is 2 to 3 times greater than a velocity of the cooling fluid passing through one of the m battery modules of the second parallel system.

8. The system of claim 1, wherein a temperature of the cooling fluid flowing into the first parallel system from the inlet is referred to as a first temperature, a temperature of the cooling fluid flowing out of the first parallel system and flowing into the second parallel system is referred to as a second temperature, and a temperature of the cooling fluid flowing out of the second parallel system and flowing into the third parallel system is referred to as a third temperature, the second temperature is higher than the first temperature, and the third temperature is higher than the second temperature,
wherein a difference in a flow rate of cooling fluid flowing into each of the battery modules of the first parallel system and a flow rate of cooling fluid flowing into each of the battery modules of the second parallel system is adjusted in proportion to a difference between the first temperature and the second temperature, and
wherein a difference between a flow rate of cooling fluid flowing into each of the battery modules of the second parallel system and a flow rate of cooling fluid flowing into each of the battery modules of the third parallel system is adjusted in proportion to a difference between the second temperature and the third temperature.

9. The system of claim 8, wherein:
n, the number of battery modules of the first parallel system, is at least twice m, the number of battery modules of the second parallel system, and
m, the number of battery modules of the second parallel system, is at least twice s, the number of battery modules of the third parallel system.

10. A battery module cooling system comprising:
at least first to third parallel systems operatively coupled in series,
wherein the cooling fluid is introduced into the first parallel system for cooling a first plurality of battery modules,
wherein the cooling fluid exiting from the first parallel system is fed to the second parallel system for cooling a second plurality of battery modules,
wherein the cooling fluid exiting from the second parallel system is fed into the third parallel system for cooling one or more battery modules,
wherein the second plurality of battery modules is less than the first plurality of battery modules,
wherein the one or more battery modules of the third battery system is less than the second plurality of battery modules, and
wherein the cooling fluid volumetric flow rate through the second parallel system is greater than the fluid volumetric flow rate of the cooling fluid through the first parallel system, and
wherein the cooling fluid volumetric flow rate through the third stage is greater than the cooling fluid volumetric flow rate through the second parallel system.

11. The system of claim 10, wherein:
the cooling fluid is supplied evenly to each of the first plurality of battery modules of the first parallel system,
the cooling fluid that has passed through the first parallel system is supplied evenly to each of the second plurality of battery modules of the second parallel system, and
the cooling fluid that has passed through the second parallel system is supplied evenly to each of the one or more battery modules of the third parallel system.
